(19) United States
(12) Patent Application Publication
(10) Pub. No.: US 2011/0119166 A1
(43) Pub. Date: May 19, 2011

(54) SYSTEM AND METHOD FOR RENEWABLE ENERGY GENERATION

(76) Inventor: Leon Steinberg, Minneapolis, MN (US)

(21) Appl. No.: 12/947,595

(22) Filed: Nov. 16, 2010

Related U.S. Application Data
(60) Provisional application No. 61/261,645, filed on Nov. 16, 2009.

(51) Int. Cl. G06Q 30/00; G06Q 10/00

(52) U.S. Cl. 705/34

(57) ABSTRACT

A system to offset the costs of a renewable energy generation facility may include a renewable energy generation facility to generate renewable electrical energy. The renewable energy generation facility may be deployed by at least one independent power producer that at least in pail arranges for the installation and deployment of the renewable energy generation facility. The system may also include a power system of transmission and distribution lines to transmit electrical energy from the renewable energy generation facility to one or more electrical access points of respective power users. The power transmission system may be operated by a power utility independent of the independent power producer. Further there may be one or more computer systems to prepare electronic billing data to be used to bid the at least one power user a minimum amount based on estimated power usage of the power user. The computer systems may also schedule a financial support payment to be made by the power user to the independent power producer. The payment made to the independent power producer may be made in exchange for a financial interest or benefit provided by the independent power producer to the power user.

### CROSS-RELATED APPLICATIONS

This non-provisional patent application claims the benefit of the filing date of U.S. Provisional Patent Application Ser. No. 61/261,645; filed Nov. 16, 2009; and entitled, “System and Method for Renewable Energy Generation,” the contents of which is incorporated by reference herein.

### BACKGROUND

Power utility companies are required by law in some jurisdictions to obtain a certain percentage of their energy from renewable sources. Many power users are concerned with the impact their power usage has on the environment. Mary large power users are also interested in using renewable power.

### BRIEF DESCRIPTION OF THE DRAWINGS

Some embodiments are illustrated by way of example and not limitation in the figures of the accompanying drawings in which:

FIG. 1 is a system diagram of a power transmission system, according to an example embodiment of the present subject matter;

FIG. 2 illustrates a block diagram of a computer system, according to an example embodiment of the present subject matter.

FIGS. 3-5 are flow diagrams of methods for implementing a renewable energy offset program according to example embodiments of the present subject matter; and

FIG. 6 illustrates a block diagram of a computer system, according to an example embodiment of the present subject matter.

FIG. 7 illustrates a graph of a dynamic fee arrangement, according to an example embodiment of the present subject matter.

### DETAILED DESCRIPTION

The following detailed description includes references to the accompanying drawings, which form a part of the detailed description. The drawings show, by way of illustration, specific embodiments in which the invention may be practiced. These embodiments, which are also referred to herein as “examples,” are illustrated in enough detail to enable those skilled in the art to practice the invention. The embodiments may be combined, other embodiments may be utilized, or structural, logical, and electrical changes may be made without departing from the scope of the present invention. The following detailed description is, therefore, not to be taken in a limiting sense, and the scope of the present invention is defined by the appended claims and their equivalents.

In various jurisdictions some power utility companies (e.g., electric power utilities) are required by law to obtain a certain amount (e.g., a certain percentage) of their energy from renewable sources. In an example embodiment renewable energy may be considered, but is not limited to, solar, wind, hydroelectric, hydrogen, geo-thermal, and biomass such as garbage gasification. The renewable energy may be produced at a renewable energy generation facility (REGF) and may be managed by a renewable energy independent power producer (IPP).

In various arrangements, a power utility company approaches a power user and offers the opportunity to obtain a certain percentage of their power from renewable resources, if the power user accepts this offer, the power user will pay a premium to the power utility company. However, in some embodiments, the power user is not able to ascertain which REGF the renewable energy is coming from. Thus, there is no direct relationship between the power user and the REGF. In various embodiments of the present subject matter an incentive program is used in which a relationship is formed between the power user and an REGF. In some embodiments a power user has relationships and financial interests in more than one REGF.

In an embodiment, the IPP contacts one or more power users directly to claim direct participation and subsidize the power generated at the REGF. A power user, in exchange for providing financial support to the REGF, may obtain a direct or indirect interest in the REGF or a payment from the REGF. In this arrangement, the power user would have a relationship separate from the power utility. In other embodiments, the power utility is aware of the relationship between the power user and the IPP. For example, the IPP may negotiate a higher price for its generated energy when the has already obtained an agreement with a power user to pay a premium for the renewable energy. In an embodiment, the power user's balance sheet is cost neutral when providing financial support to the REGF. For example, for any premium paid by the power user for renewable energy, an interest in the REGF or payment obligation will be given back to the power user, with of without interest.

In an embodiment, all three parties may see benefits in such an arrangement. For example, the power user has a potentially profitable investment and does not incur any additional cost beyond paying for renewable energy, the power utility is still obtaining its enhanced energy price and forgoes the expense of marketing the renewable energy, and the IPP may obtain a higher price for its energy and offset a portion of the REIF costs. In various embodiments, the power user will pay the power utility the financial support payment which will then funnel it to the IPP.

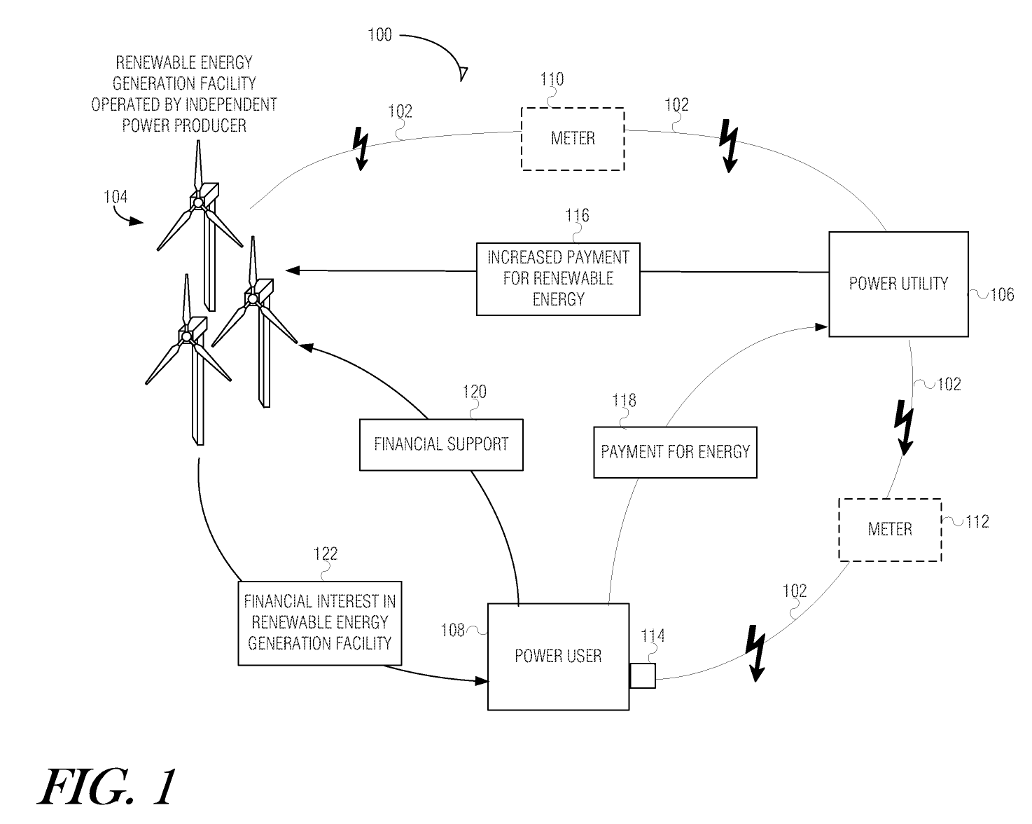

FIG. 1 is a system diagram of power system 100, according to an example embodiment of the present subject matter. Illustrated are series of transmission lines 102 that connect the REGF 104 to power utility 106 and power utility 106 to a power user 108. Further illustrated are meters 110, 112. Additionally illustrated is electrical access point 114 at power user 108. In various embodiments, the system operates in both regulated and deregulated electricity markets an embodiment, a deregulated electricity market allows a power user to choose its electricity service provider.

In addition to the physical entities displayed, financial interactions are also illustrated. In various embodiments, power utility 106 transmits a payment for renewable energy 116 to REGF 104 (e.g., to the IPP operating the REGF). Power user 108 transmits a payment for energy 118 to power utility 106 for energy used on transmission lines 102. Power user 108 may also transmit financial support 120 to the IPP operator of REGF 104 and obtains a financial interest 122 in REGF 104.

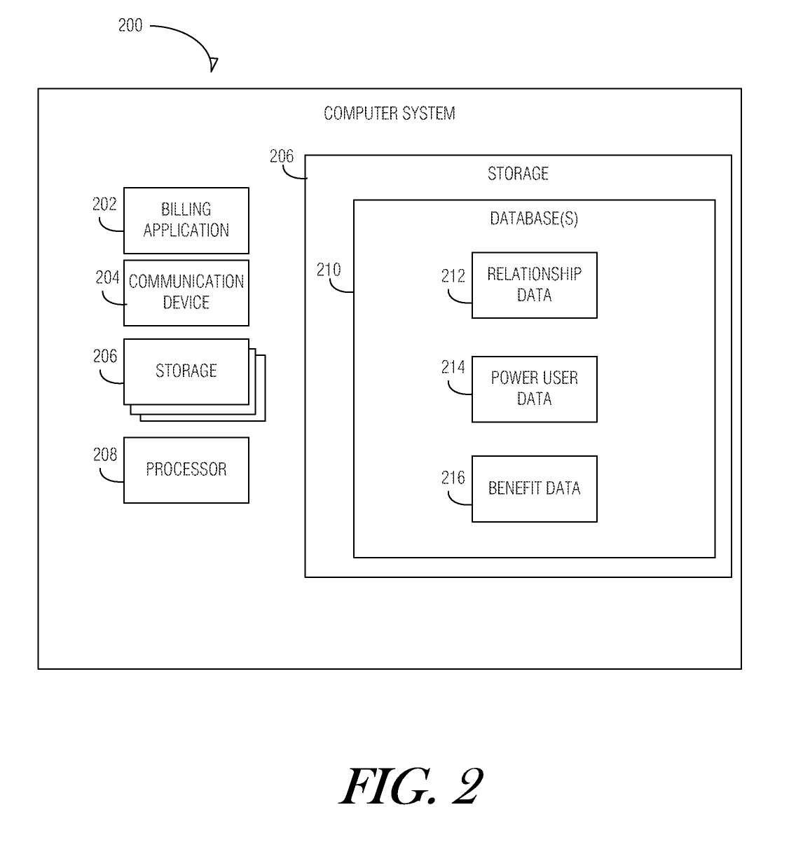

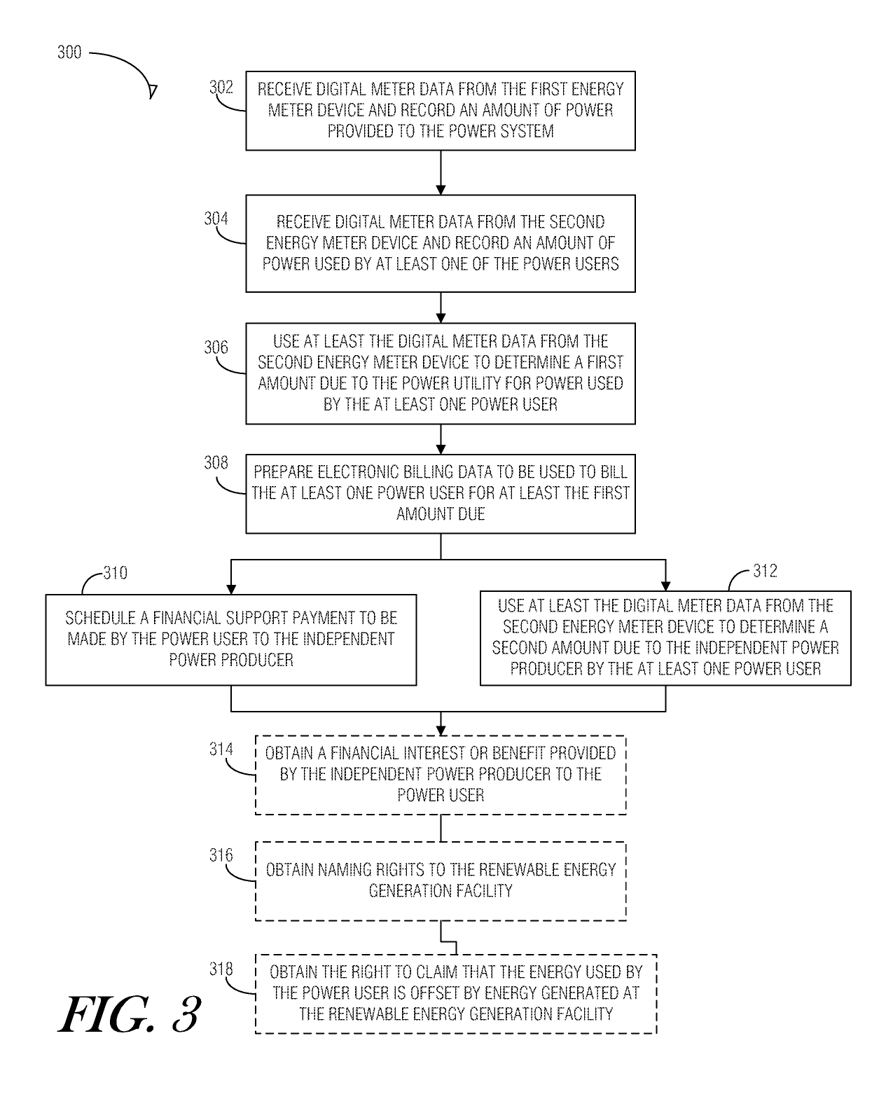

FIG. 2 is an example computer system 200. In various embodiments, the computer system comprises one or more components. These components may include billing application 202, communication interface 204, one or more storage mediums 206, processor 208, and databases 210. In various embodiments, these components interact with the entities of FIG. 1 to provide a private offset renewable energy incentive program. Example embodiments of incentive programs are illustrated in FIGS. 3-5. One or more of computer systems 200 may be located at various locations in the power transmission system and communicate with each other via a communications network (e.g., the Internet) to implement the incentive programs. In an example embodiment, databases 210 include data representing the various entities involved in the power system. The database may store relationship data 212 (e.g., indicia indicating how the various entities involved in FIG. 1 are related), power user data 214 (e.g., identifying information), and benefit data 216 the various benefits that may be given to a power user). In various embodiments the databases store benefit data representing possible benefits given to power users by the independent power producer in exchange for a financial support payment, wherein the database stores relationship data representing relationships between the power users and the benefit data. For example, there may be an entry that links a power user to an independent power producer through a specific benefit (e.g., Power User 1, REGF 1, benefit naming rights to REGF 1).

In an example embodiment, there is a renewable energy generation facility to generate renewable electrical energy. The REGF may be a wind turbine power generation facility, a hydro-power generating facility, a solar energy power generation facility, a garbage gasification facility or a geo-themial power generation system. The REGF may be deployed by at least one IPP that at least partially arranges for the installation and deployment of the renewable energy generation facility. Additionally, there is a power system of transmission and distribution lines to transmit electrical energy from the REGF to one or more electrical access points of power users. In an embodiment, the power transmission system is operated by a power utility independent of the IPP. In an embodiment, the power transmission system is owned and operated by the IPP or the power user.

As illustrated in FIG. 1, there may be at least one energy meter device (e.g., meter 110) to measure electrical energy supplied to the power transmission system from the renewable energy generation facility. In further embodiments, there may be no meter devices needed to enable a power user to provide financial support to an REGF and for the power user to obtain a financial interest in the REGF. The first energy meter device may include an output circuit to output digital meter data indicative of a quantity of energy passing through the first energy meter device. There may also be a second meter (e.g., meter 112) positioned at one of the access points and connected between the power transmission system and electrical supply lines of an energy consumer. The second energy meter device may include an output circuit to output digital meter data indicative of a quantity of energy passing through the second energy meter device. Thus, in an example embodiment it is known how much energy is being provided by an REGF and how much energy is being used by a consumer or power user.

FIG. 3 illustrates an example method 300 of an incentive program that may be implemented on a computer system such as computer system 200. At block 302 digital meter data is received at a computer system from a first energy meter device between the REGF and the power utility. The data includes information on the amount of power provided to the power system from the REGF. This may be recorded on one or more storage mediums in the computer system. For example, the data may be stored in a database or flatfile on a hard disk drive. Using computer system 200 as an example, application 202 may be executed on processor 208 which configures communication device 204 to receive the data and store it on storage 206. In various embodiments, a meter may include a counter indicating an amount of energy that passes through the meter (e.g., the amount of energy used or transmitted).

At block 304, according to an example embodiment, digital meter data from a second energy meter device positioned at an access point of a power user is received. In an embodiment, this data is received by the same computer system as at block 302. The meter data includes the amount of power being used by at least one power user.

At block 306, according to an example embodiment, the digital meter data from the second energy meter device is used to determine a first amount due to the power utility for power used by the at least one power user.

At block 308, according to an example embodiment, the electronic billing data is used to prepare a bill for the power user for at least the first amount due. This may be done by a billing application on a computer system.

In an example embodiment, at block 310, a financial support payment is scheduled to be made by the power user to the IPP. In an embodiment, the scheduled financial support to the IPP for the renewable energy generation facility is based upon the actual or estimated power used by the power user. For example, a fixed fee may initially be paid and then modified based on actual usage. In another example, the financial support may be determined by KW hour of power usage.

In embodiments where meters are not used, a minimum fee, fixed fee, or dynamic fee may be made to the IPP by the power user. In some embodiments, in order to obtain financing for the REGF, the IPP must show a consistent amount of income each month. Thus, a fixed fee or minimum fee arrangement between the IPP and the power user may be more beneficial than one based on meter data alone. In an embodiment, the fee may be based on estimated usage. In yet another embodiment, the fee may be based on the amount of power generated by the REGF.

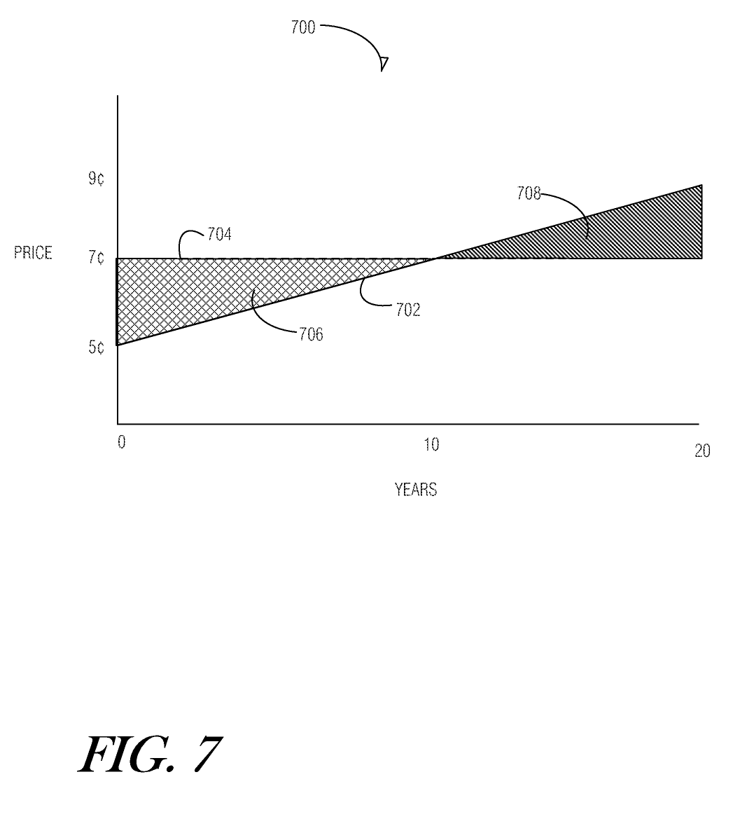

FIG. 7 illustrates a graph 700 of a dynamic fee arrangement. The dynamic fee may be based on a power purchase agreement between the IPP and the power utility. For example, in some arrangements the power utility pays the IPP on escalating amount 702 of money for each KW hour of energy over a predetermined time period (e.g., twenty years). Illustrated is an initial five cents per KW hour at year zero and nine cents per KW hour at year twenty. In an embodiment, the IPP normalizes this escalating fee at seven cents per KW (shown as line 704).

In order to normalize the fee, the IPP obtains the difference between what the power utility is paying for the renewable energy and the normalized amount from a power user. Thus, at year zero the power user is making payments equivalent to two cents per KW hour, and at year ten the power user is paying zero. Area 706 illustrates the dynamic fee that the power user pays to the IPP. Area 708 illustrates payments going from the IPP to the power user. Because, after year ten, the utility is now paying more than the normalized seven cents per KW hour, the IPP pays the difference back to the power user. In some embodiments, after the IPP has made the power user whole, payments are continued to be made to the power user from the IPP. In an embodiment, the payment is based on the last amount paid to the power user from the IPP (e.g., two cents per KW hour at year twenty).

At block 312, in an example embodiment, a second amount due to the IPP is determined using at least the digital meter data from the second energy meter device. In an embodiment, the second amount due is considered economic support paid by the at least one power user.

In various embodiments, the economic support or payments are made to the IPP in exchange for one or more of the following: a financial interest or benefit provided by the IPP to the power user (block 314), naming rights to the REGF (block 316), or that the energy used by the power user is offset by energy generated at the REGF (block 318). Additionally, the IPP may deploy or operate the REGF with the economic support from the power user making the REGF economically feasible.

In one or more example embodiments, the financial benefit or interest is one or more of the following: a) an ownership interest in the renewable energy facility, b) carbon credits, renewable energy credits, green tags or similar items, c) a profit interest in the renewable energy facility, or d) an interest payment. Ownership interests may be for a limited time period (e.g., ten years).

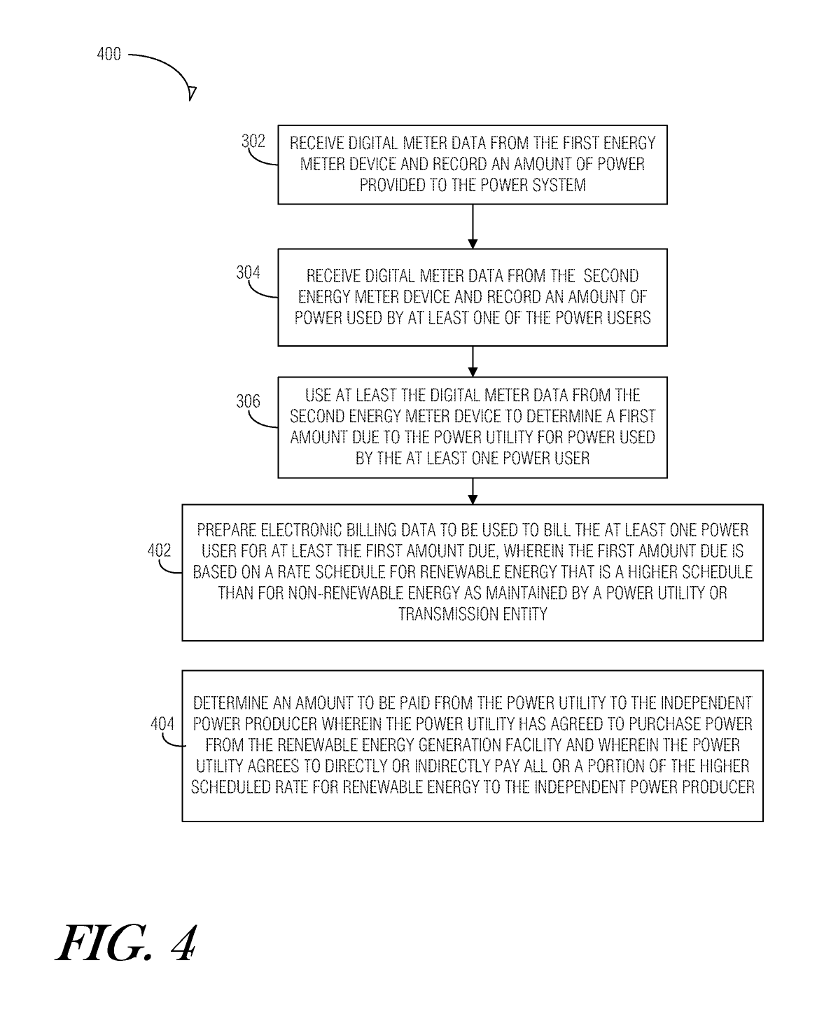

FIG. 4 illustrates another incentive program 400. Blocks 302, 304, and 306 may be the same as those discussed with reference to FIG. 3. At block 402, electronic billing is prepared (e.g., on computer system 200 using billing application 202) to bill the at least one power user for at least the first amount due. The first amount due may be based on a rate schedule for renewable energy that is a higher schedule than for non-renewable energy as maintained by a power utility or transmission entity.

At block 404, an amount to be paid from the power utility to the IPP is determined. In an example embodiment, the power utility has agreed to purchase power from the REGF. Furthermore, in an example, the power utility agrees to directly or indirectly pay all or a portion of the higher scheduled rate for renewable energy to the independent power producer.

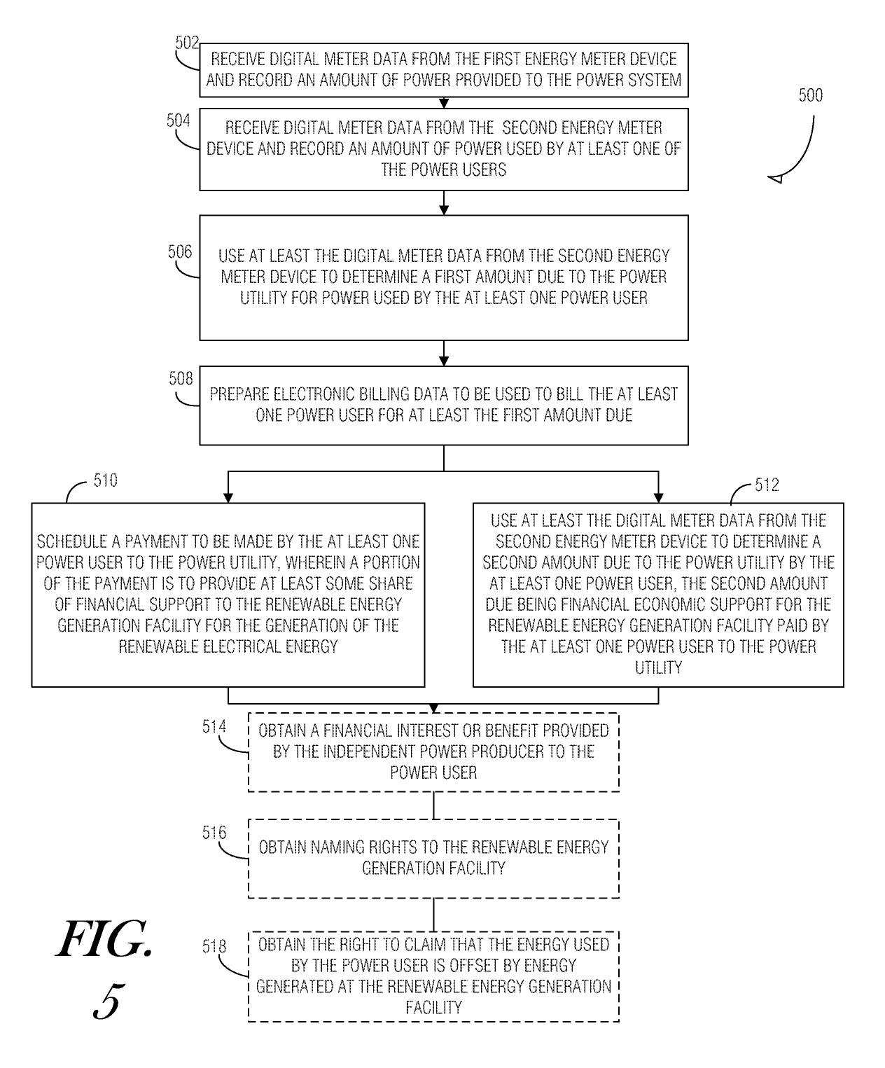

FIG. 5 illustrates an incentive program similar to those described in FIGS. 3-4, but instead of the power user paying the IPP/REGF, the power user pays the power utility. At block 502 digital meter data is received at a computer system from a first energy meter device between the REGF and the power utility. The data includes information on the amount of power provided to the power system from the REGF. This may be recorded on one or more storage mediums in the computer system. For example, the data may be stored in a database or flatfile on a hard disk drive. Using computer system 200 as an example, billing application 202 may be executed on processor 208 which configures communication device 204 to receive the data and store it on storage 206.

At block 504, according to an example embodiment, digital meter data from a second energy meter device positioned at an access point of a power user is received. In an embodiment, this data is received by the same computer system as at block 302. The meter data includes the amount of power being used by at least one power user.

At block 506, according to an example embodiment, the digital meter data from the second energy meter device is used to determine a first amount due to the power utility for power used by the at least one power user.

At block 508, according to an example embodiment, the electronic billing data is used to prepare a bill for the power user for at least the first amount due.

At block 510, according to an example embodiment, a payment to be made by the at least one power user to the power utility is scheduled. A portion of the payment may provide at least some share of financial support to the REGF for the generation of the renewable electrical energy.

At block 512, according to example embodiment, the digital meter data from the second energy meter device is used to determine a second amount due to the power utility by the at least one power user. The second amount due being financial economic support for the REGF paid by the at least one power user to the power utility. In embodiments where meters are not used, a minimum fee or fixed fee may be made to the power utility by the power user. The fee may then be transferred from the power utility to the REGF.

In various embodiments, the economic support or payments are made to the power utility in exchange for one or more of the following: a financial interest or benefit provided by the IPP to the power user (block 514), naming rights to the REGF (block 516), or the right to claim that the energy used by the power user is offset by energy generated at the REGF (block 5(8). Additionally, the IPP may deploy or operate the REGF with the economic support from the power user.

### A Computer System

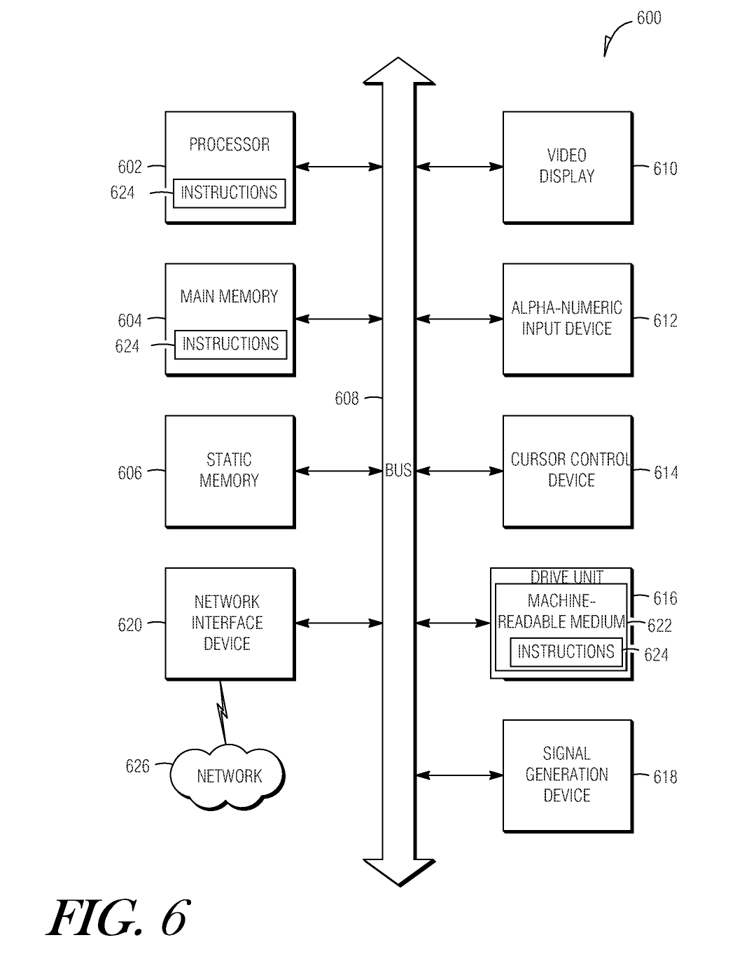

FIG. 6 shows a diagrammatic representation of a machine in the example form of a computer system 600 within which a set of instructions for causing the machine to perform any one or more of the methods, processes, operations, or methodologies discussed herein may be executed. Computer system 600 may serve as an example of a more detailed version of computer system 200. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a Personal Computer (PC), a tablet PC, a Set-Top Box (STB), a Personal Digital Assistant (PDA), cellular telephone, a Web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Example embodiments can also be practiced in distributed system environments where local and remote computer systems which that are linked (e.g., either by hardwired, wireless, or a combination of hardwired and wireless connections) through a network, both perform tasks. In a distributed system environment, program modules may be located in both local and remote memory-storage devices (see below).

The example computer system 600 includes a processor 602 (e.g., a Central Processing Unit (CPU), a Graphics Processing Unit (GPU) or both), a main memory 601 and a static memory 606, which communicate with each other via a bus 608. The computer system 600 may further include a video display unit 610 (e.g., a Liquid Crystal Display (LCD) or a Cathode Ray Tube (CRT)). The computer system 600 also includes an alphanumeric input device 612 (e.g., a keyboard), a User Interface (UI) cursor controller 614 (e.g., a mouse), a disk drive unit 616, a signal generation device 618 (e.g., a speaker) and a network interface device 620 (e.g., a transmitter).

The disk drive unit 616 includes a machine-readable medium 622 on which is stored one or more sets of instructions 624 and data structures (e.g., software) embodying or used by any one or more of the methodologies or functions illustrated herein. The software ma also reside, completely or at least partially, within the main memory 604 and/or within the processor 602 during execution thereof by the computer system 600, the main memory 604 and the processor 602 also constituting machine-readable media.

The instructions 624 may further be transmitted or received over a network 626 via the network interface device 620 using any one of a number of well-known transfer protocols (e.g., HTTP, Session Initiation Protocol (SIP)).

The term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding, or carrying a set of instructions for execution by the machine and that cause the machine to perform any of the one or more of the methodologies illustrated herein. The term “machine-readable medium” shall accordingly be taken to include, but not be limited to, solid-state memories, and optical and magnetic medium.

What is claimed is:

1. A system comprising:
a renewable energy generation facility to generate renewable electrical energy, the renewable energy generation facility deployed by an independent power producer that at least in part arranges for the installation and deployment of the renewable energy generation facility;
a power system of transmission and distribution lines to transmit electrical energy from the renewable energy generation facility to one or more electrical access points of respective power users, the power transmission system operated by a power utility independent of the independent power producer;
a database stored on a memory device, wherein the database stores user data representing the power users, and wherein the database stores benefit data representing possible benefits given to power users by the independent power producer in exchange for a financial support payment, and wherein the database stores relationship data representing relationships between the power users and the benefit data and
one or more computer systems to:
generate electronic bitting data to be used to bill a power user of the respective power users; and
generate scheduling data representing a financial support payment to be made by the power user to the independent power producer, wherein the financial support payment made to the independent power producer is in exchange for a benefit based on the relationship data between the power user and the benefit data.

2. A system according to claim 1, wherein the benefit data representing possible benefits given to power users by the independent power producer includes entries representing benefits of one or more of the following:
a) naming rights to the renewable energy generation facility;
b) the right to claim that the energy used by the power user is offset by energy generated at the renewable energy generation facility;
c) the right to claim that the payments made to the IPP enable the renewable energy generation facility to be economically viable; or
d) an ownership interest in carbon credits, renewable energy certificates, or green tags.

3. A system according to claim 1, wherein the billing data is based on one of the following:
a) a minimum amount based on estimated power usage of the power user;
b) a fixed fee;
c) estimated power usage of the power user;
d) a dynamic fee based on normalizing an escalating power purchase agreement between the power utility and the IPP; or
e) a fee based upon power output generated by the renewable energy generation facility.

4. A system according to claim 1, wherein the scheduled financial support to the independent power producer for the renewable energy generation facility is based upon the actual or estimated power used by the power user.

5. A system according to claim 1, wherein the benefit data representing possible benefits is one or more of the following:
a) an ownership interest in the renewable energy generation facility;
b) a profit interest in the renewable energy generation facility; or
c) a financial payment.

6. A system comprising:
a renewable energy generation to generate renewable electrical energy, the renewable energy generation facility deployed by an independent power producer that at least in part arranges for the installation and deployment of the renewable energy generation facility;
a power system of transmission and distribution lines to transmit electrical energy from the renewable energy generation facility to one or more electrical access points of respective power users, the power transmission system operated by a power utility independent of the independent power producer;
at least one first energy meter device to measure electrical energy supplied to the power transmission system from the renewable energy generation facility, the first energy meter device including an output circuit to output digital meter data indicative of a quantity of energy passing through the first energy meter device;
at least one second energy meter device positioned at one of the electrical access points and connected between the power transmission system and electrical supply lines of an energy consumer, the second energy meter device including an output circuit to output digital meter data indicative of a quantity of energy passing through the second energy meter device;
a database stored on a memory device, wherein the database stores user data representing the power users, and wherein the database stores benefit data representing possible benefits given to power users by the independent power producer in exchange for a financial support payment, and wherein the database stores relationship data representing relationships between the power users and the benefit data; and
one or more computer systems to:
receive digital meter data from the first energy meter device and record an amount of power provided to the power system;
receive digital meter data from the second energy meter device and record an amount of power used by a power user of the respective power users;
use the digital meter data from the second energy meter device to determine a first amount due to the power utility for power used by the power user;
generate electronic billing data to be used to bill the power user for the first amount due; and
use the digital meter data from the second energy meter device to determine a second amount due to the independent power producer by the power user, the second amount due being economic support paid by the power user in exchange for one or more of the following:
a) a financial interest or benefit provided by the independent power producer to the power user;
b) naming rights to the renewable energy generation facility;
c) the right to claim that the energy used by the power user is offset by renewable energy from the renewable energy generation facility; or
d) the right to claim that the payments made to the IPP enable the renewable energy generation facility to be economically viable.

7. A system according to claim 6, wherein the independent power producer deploys or operates the renewable energy generation facility with the financial support payment from the power user.

8. A system according to claim 6 wherein the financial benefit or interest is one or more of the following:
a) an ownership interest in the renewable energy generation facility;
b) a profit interest in the renewable energy facility; or
c) a financial payment.

9. A system comprising:
a renewable energy generation to generate renewable electrical energy, the renewable energy generation facility deployed by at least one independent power producer that at least in part arranges for the installation and deployment of the renewable energy generation facility;
a power system of transmission and distribution lines to transmit electrical energy from the renewable energy generation facility to one or more electrical access points of respective power users, the power transmission system operated by a power utility independent of the independent power producer;
at least one first energy meter device to measure electrical energy supplied to the power transmission system from the renewable energy generation facility, the first energy meter device including an output circuit to output digital meter data indicative of a quantity of energy passing through the first energy meter device;
at least one second energy meter device positioned at one of the electrical access points and connected between the power transmission system and electrical supply lines of an energy consumer, the second energy meter device including an output circuit to output digital meter data indicative of a quantity of energy passing through the second energy meter device;
a database stored on a memory device, wherein the database stores user data representing the power users, and wherein the database stores benefit data representing possible benefits given to power users by the independent power producer in exchange for a financial support payment, and wherein the database stores relationship data representing relationships between the power users and the benefit data; and
one or more computer systems to:
receive digital meter data from the first energy meter device and record an amount of power provided to the power system;
receive digital meter data from the second energy meter device and record an amount of power used by a power user of the respective power users;
use the digital meter data from the second energy meter device to determine a first amount due to the power utility for power used by the at least one power user;
generate electronic billing data to be used to bill the power user for at least the first amount due, wherein the first amount due is based on a rate schedule for renewable energy that is a higher schedule than for non-renewable energy as maintained by a power utility or transmission entity; and
determine an amount to be paid from the power utility to the independent power producer wherein the power utility has agreed to purchase power from the renewable energy generation facility and wherein the power utility agrees to directly or indirectly pay all or a portion of the higher scheduled rate for renewable energy to the independent power producer.

10. A system according to claim 9, wherein the power user is allocated renewable energy from the transmission and distribution system based on the supply of the renewable energy to the transmission system by the renewable energy generation facility.

11. A system according to claim 9, wherein the renewable energy generation facility is selected from the group including a wind turbine power generation facility, a hydro-power generating facility, a solar energy power generation facility, a garbage gasification facility or a geo-thermal power generation system.

12. A system comprising:
a renewable energy generation to generate renewable electrical energy, the renewable energy generation facility deployed by an independent power producer that at least in part arranges for the installation and deployment of the renewable energy generation facility;
a power system of transmission and distribution lines to transmit electrical energy from the renewable energy generation facility to one or more electrical access points of respective power users, the power transmission system operated by a power utility independent of the independent power producer;
at least one first energy meter device to measure electrical energy supplied to the power transmission system from the renewable energy generation facility, the first energy meter device including an output circuit to output digital meter data indicative of a quantity of energy passing through the first energy meter device;
at least one second energy meter device positioned at one of the electrical access points and connected between the power transmission system and electrical supply lines of an energy consumer, the second energy meter device including an output circuit to output digital meter data indicative of a quantity of energy passing through the second energy meter device;
a database stored on a memory device, wherein the database stores user data representing the power users, and wherein the database stores benefit data representing possible benefits given to power users by the independent power producer in exchange for a financial support payment, and wherein the database stores relationship data representing relationships between the power users and the benefit data; and
one or more computer systems to:
receive digital meter data from the first energy meter device and record an amount of power provided to the power system;
receive digital meter data from the second energy meter device and record an amount of power used by a power user of the respective power users;
use the digital meter data from the second energy meter device to determine a first amount due to the power utility for power used by the at least one power user;
generate electronic billing data to be used to bill the at least one power user for at least the first amount due; and
wherein the power user provides financial support to the independent power producer and wherein the financial support is made to the independent power producer is in exchange for one or more of the following:
a) an financial interest or benefit provided by the independent power producer to the power user;
b) naming rights to the renewable energy generation facility;
c) the right to claim that the energy used by the power user is offset by energy generated at the renewable energy generation facility; or
d) the right to claim that the payments made to the IPP enable the renewable energy generation facility to be economically viable.

13. A system according to claim 12, wherein the independent power producer deploys or operates the renewable energy generation facility with the financial support from the power user.

14. A system according to claim 12, wherein the financial support to the independent power producer for the renewable energy generation facility is based upon a dynamic fee based on normalizing an escalating power purchase agreement between the power utility and the IPP.

15. A system according to claim 12, wherein the financial benefit or interest is one or more of the following:
a) an ownership interest in the renewable energy generation facility;
b) a profit interest in the renewable energy generation facility; or
c) a financial payment.

16. A system comprising:
a renewable energy generation facility to generate renewable electrical energy, the renewable energy generation facility deployed by an independent power producer that at least in part arranges for the installation and deployment of the renewable energy generation facility;
a power system of transmission and distribution lines to transmit electrical energy from the renewable energy generation facility to one or more electrical access points of respective power users, the power transmission system operated by a power utility independent of the independent power producer;
a database stored on a memory device, wherein the database stores user data representing the power users, and wherein the database stores benefit data representing possible benefits given to power users by the independent power producer in exchange for a financial support payment, and wherein the database stores relationship data representing relationships between the power users and the benefit data; and
one or more computer systems to:
generate electronic billing data to be used to bill the a power user of the respective power users; and
generate scheduling data representing a payment to be made by the at least one power user to the power utility, wherein the payment made to the power utility is in exchange for a benefit provided by the independent power producer to the power user.

17. A system according to claim 16, wherein the benefit data representing possible benefits given to power users by the independent power producer includes entries representing benefits of one or more of the following:
a) naming rights to the renewable energy generation facility;
b) the right to claim that the energy used by the power user is offset by energy generated at the renewable energy generation facility; or
c) the right to claim that the payments made to the IPP enable the renewable energy generation facility to be economically viable.

18. A system according to claim 16, wherein benefit data representing possible benefits is one or more of the following:
a) an ownership interest in the renewable energy generation facility;
b) a profit interest in the renewable energy generation facility; or
c) a financial payment.

19. A system according to claim 16, wherein the billing data is based on one of the following:
a) a minimum amount based on estimated power usage of the power user;
b) a fixed fee;
c) estimated power usage of the at least one power user;
d) a dynamic fee based on normalizing an escalating power purchase agreement between the power utility and the IPP; or
e) a fee based upon power output generated by the renewable energy generation facility.

20. A system comprising:
a renewable energy generation to generate renewable electrical energy, the renewable energy generation facility deployed by at least one independent power producer that at least in part arranges for the installation and deployment of the renewable energy generation system;
a power system of transmission and distribution lines to transmit electrical energy from the renewable energy generation facility to one or more electrical access points of respective power users, the power transmission system operated by a power utility independent of the independent power producer;
at least one first energy meter device to measure electrical energy supplied to the power transmission system from the renewable energy generation system, the first energy meter device including an output circuit to output digital meter data indicative of a quantity of energy passing through the first energy meter device;
at least one second energy meter device positioned at one of the access points and connected between the power transmission system and electrical supply lines of an energy consumer, the second energy meter device including an output circuit to output digital meter data indicative of a quantity of energy passing through the second energy meter device;
a database stored on a memory device, wherein the database stores user data representing the power users, and wherein the database stores benefit data representing possible benefits given to power users by the independent power producer in exchange for a financial support payment, and wherein the database stores relationship data representing relationships between the power users and the benefit data; and
one or more computer systems to:
receive digital meter data from the first energy meter device and record an amount of power provided to the power system;
receive digital meter data from the second energy meter device and record an amount of power used a power user of the respective power users;
use at least the digital meter data from the second energy meter device to determine a first amount due to the power utility for power used by the power user;
generate electronic billing data to be used to bill the power user for al least the first amount due; and
use at least the digital meter data from the second energy meter device to determine a second amount due to the power utility by the power user, the second amount due being financial economic support for the renewable energy generation facility paid by the power user to the power utility in exchange for one or more of the following:
a) a financial interest or benefit provided by the independent power producer to the power user;
b) naming rights to the renewable energy generation facility;
c) the right to claim that the energy used by the power user is offset by energy generated al the renewable energy generation facility; or
d) the right to claim that the payments made to the IPP enable the renewable energy generation facility to be economically viable.

21. A system according to claim 20, wherein the financial benefit or interest is one or more of the following:
a) an ownership interest in the renewable energy generation facility;
b) a profit interest in the renewable energy generation facility; or
c) a financial payment.

22. A system comprising:
a renewable energy generation facility to generate renewable electrical energy, the renewable energy generation facility deployed by at least one independent power producer that at least in part arranges for the installation and deployment of the renewable energy generation system;
a power system of transmission and distribution lines to transmit electrical energy from the renewable energy generation facility to one or more electrical access points of respective power users, the power transmission system operated by a power utility independent of the independent power producer;
at least one first energy meter device to measure electrical energy supplied to the power transmission system from the renewable energy generation facility, the first energy meter device including an output circuit to output digital meter data indicative of a quantity of energy passing through the first energy meter device;
at least one second energy meter device positioned at one of the access points and connected between the power transmission system and electrical supply lines of an energy consumer, the second energy meter device including an output circuit to output digital meter data indicative of a quantity of energy passing through the second energy meter device;
a database stored on a memory device, wherein the database stores user data representing the power users, and wherein the database stores benefit data representing possible benefits given to power users by the independent power producer in exchange for a financial support payment, and wherein the database stores relationship data representing relationships between the power users and the benefit data: and
one or more computer systems to:
receive digital meter data from the first energy meter device and record an amount of power provided to the power system;
receive digital meter data from the second energy meter device and record an amount of power used by a power user of the respective power users;
use at least the digital meter data from the second energy meter device to determine a first amount due to the power utility for power used by the power user;
generate electronic billing data to be used to bill the power user for at least the first amount due; and
wherein the power user provides a payment to the power utility for financial economic support for the renewable energy generation facility and wherein the financial support is made to the power utility in exchange for one or more of the following:
a) an financial interest or benefit provided by the independent power producer to the power user;
b) naming rights to the renewable energy generation facility; or
c) the right to claim that the energy used by the power user is offset by energy generated at the renewable energy generation facility.

23. A system according to claim 22, wherein the independent power producer deploys or operates the renewable energy generation facility with the financial economic support from the power user.
